(19) United States
(12) Patent Application Publication
(10) Pub. No.: US 2013/0244862 A1
(43) Pub. Date: Sep. 19, 2013

(54) PROCESS FOR MANUFACTURING A NITROGEN-CONTAINING POROUS CARBONACEOUS MATERIAL

(71) Applicants: Sorin Ivanovici, Heidelberg (DE); Klaus Muellen, Koeln (DE); Matthias Schwab, Mannheim (DE); Liang Yanyu, Nanjing (CN)

(72) Inventors: Sorin Ivanovici, Heidelberg (DE); Klaus Muellen, Koeln (DE); Matthias Schwab, Mannheim (DE); Liang Yanyu, Nanjing (CN)

(73) Assignees: Max-Planck-Gesellschaft zur Foerderung der Wissenschaften e.V., Muenchen (DE); BASF SE, Ludwigshafen (DE)

(21) Appl. No.: 13/988,895

(22) PCT Filed: Nov. 24, 2011
(86) PCT No.: PCT/IB11/55282

§ 371 Date: May 22, 2013

Related U.S. Application Data
(60) Provisional application No. 61/417,297, filed on Nov. 26, 2010.

(30) Foreign Application Priority Data
Nov. 26, 2010 (EP) 10192768.9

(51) Int. Cl. H01M 4/90

(52) U.S. Cl. CPC H01M 4/9008
USPC 502/101; 502/167

(57) ABSTRACT

Disclosed is a process for manufacturing a nitrogen-containing porous carbonaceous material with an optional inorganic salt content of up to 50 ppm by weight. The process comprises the following steps: (A) conversion of (a) at least one heterocyclic hydrocarbon with at least two NH2-groups per molecular with (b) at least one aromatic compound with at least two aldehyde groups per molecular, (B) heating in the absence of oxygen to temperature in the range of from 700 to 1200° C.

This invention is directed towards a process for manufacturing a nitrogen-containing porous carbonaceous material with an optional inorganic salt content of up to 50 ppm by weight, comprising the following steps:

(A) conversion of
(a) at least one heterocyclic hydrocarbon with at least two NH₂-groups per molecule with
(b) at least one aromatic compound with at least two aldehyde groups per molecule,

(B) heating in the absence of oxygen to temperatures in the range of from 700 to 1200° C.

Furthermore, the present invention is directed towards carbonaceous materials which are well suitable for capacitors.

Electrochemical energy as a clean power source has sparked great fundamental and industrial interest. Capacitors such as electrochemical double-layer capacitors (EDLC), herein briefly also referred to as capacitors, are electrical devices that store and release energy by nanoscopic charge separation at the interface of a high-surface-area electrode and an electrolyte, see, e.g., R. Kötz et al., Electrochim. Acta 2000, 45, 2483 and D. Hulicova-Jurcakova et al., Adv. Funct. Mater. 2009, 19, 1800.

In contrast to batteries, capacitors are capable of releasing and taking up energy within short time. An obstacle to a wider application today is their low energy density, see, e. g., B. E. Conway, Electrochemical Supercapacitors: scientific fundamentals and technological aspects. Kluwer Academic/Plenum Publishers: New York (1999). The energy density of capacitors, batteries and other energy storage devices can be visualized e. g., in the Ragone plot.

Many modern capacitors are based on activated carbon or ruthenium materials. However, the often undefined pore structure of activated carbon does not result in optimal electrochemical kinetics during energy uptake and release. In addition the high price of ruthenium materials is disadvantageous. It is therefore an objective to provide materials for capacitors that possess better electrochemical kinetics during energy uptake and release, or that are inexpensive.

Further challenges for capacitors are
easy methods of fabrication
higher energy density
long-time stability.

It was an objective to provide capacitors which overcome the prior art capacitors. It was an objective to provide materials that can be used in capacitors and through which the deficiencies of the prior art capacitors can be overcome. It was further an objective to provide a process for making such materials. It was further an objective to find further applications of the new materials.

Accordingly, the process and materials defined above have been found.

The process according to the invention, hereinafter also named inventive process, is a process to make nitrogen-containing carbonaceous materials.

The term nitrogen-containing refers to carbonaceous materials that contain chemically bound nitrogen atoms. Said nitrogen can be trivalent or quaternized. Without being bound to any theory, nitrogen chemically bound into carbonaceous porous materials in the context of this invention can be part of, e. g., the following structural elements:

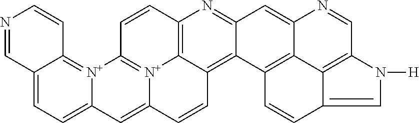 [SMILES: c1cc2c(ccc3cc4ccc5c6c(cc7ncc8[nH]cc9ccc6c7c98)nc6ccc([n+]32)[n+]4c65)cn1]

In the case of quaternized N atoms, suitable counterions are hydroxide and halide, especially chloride.

In one embodiment of the present invention, the nitrogen-content is in the range of from 1 to 8% by weight, preferably 5 to 7% by weight.

The term porous refers to carbonaceous materials that have a BET surface area in the range of from 50 to 3000 m²/g, preferred from 50 to 1500 m²/g.

The inventive process contains at least two chemical steps.

In step (A),
(a) at least one heterocyclic hydrocarbon with at least two NH₂-groups per molecule, said compound hereinafter also referred to as compound (a), is converted with
(b) at least one aromatic compound with at least two aldehyde groups per molecule, said compound hereinafter also referred to as compound (b).

Compound (a) can have at least two, preferably two to four NH₂-groups per molecule and most preferably two or three NH₂-groups. If mixtures of compounds (a) are to be employed, it is preferred that the average NH₂-group content of the compounds (a) is in the range of from 2 to 3 per mole.

Compound (a) can have one or more functional groups other than NH₂-groups. Suitable functional groups other than NH₂-groups are secondary or tertiary amino groups, keto groups and hydroxyl groups.

In a preferred embodiment, compound (a) has no functional groups other than NH₂-groups.

In step (A), compound (a) can be applied with free NH₂-groups or in protonated form, e. g. with one or two NH₃⁺-groups instead of NH₂-groups per molecule. If compound (a) bears one or more NH₃⁺-groups instead of NH₂-groups per molecule, suitable counterions are selected from organic and inorganic anions such as acetate, formate and benzoate and particularly inorganic anions such as chloride and inorganic anions that are halide free, such as phosphate, hydrogen phosphate, sulphate and hydrogen sulphate. For matters of simplicity, in the context of compound (a) NH₃⁺-groups are contemplated as NH₂-groups.

Compound (a) is selected from hydrocarbons that are heterocyclic. Compound (a) can have one or more atoms other than carbon in the heterocyclic backbone, such as nitrogen, oxygen and sulphur, preferred is nitrogen. It is possible that compound (a) has different atoms other than carbon in the heterocyclic backbone, for example one nitrogen atom and one oxygen atom. Preferably, compound (a) has only carbon atoms and one or more nitrogen atoms in its heterocylic backbone.

In one embodiment of the present invention, compound (a) can have in the range of from 3 to 20 carbon atoms per molecule, preferred are 3 to 10 carbon atoms per molecule.

In one embodiment of the present invention, one or more NH₂-groups of compound (a) are directly linked to the heterocyclic backbone of compound (a). In a particular embodiment of the present invention, all NH₂-groups of compound (a) are directly linked to the heterocyclic backbone of compound (a).

In one embodiment of the present invention, one or more NH₂-groups of compound (a) are linked to the heterocyclic backbone of compound (a) through a spacer with one or more carbon atoms, such as —CH₂—, —C(O)—, —CH(CH₃)—, —CH₂CH₂—, —(CH₂)₃—, —NH—(CH₂)₃— or C(O)—CH₂—CH₂—. In a particular embodiment of the present invention, all NH₂-groups of compound (a) are linked to the heterocyclic backbone of compound (a) through a spacer with one or more carbon atoms which may be different, equal or identical. E. g., an example for the latter embodiment is a spacer that bears two NH₂-groups, such as CH(NH₂)—CH₂—NH_{2.}

In one embodiment of the present invention, one or more NH₂-groups of compound (a) are directly linked to the heterocyclic backbone of compound (a) and one or more NH₂-groups of compound (a) are linked to the heterocyclic backbone of compound (a) through a spacer, said spacer being defined above.

Compound (a) can have a non-aromatic or aromatic backbone. Suitable non-aromatic backbones are

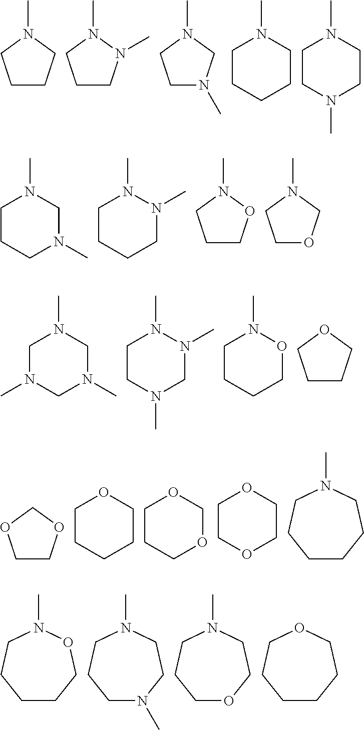

The backbone of compound (a) is substituted by at least one, preferably at least two groups per molecule that are selected from NH₂-groups and spacers with one or more NH₂-groups.

The backbone of compound (a) can bear one or more substituents other than the ones listed above, such as OH groups, C₁-C₆-alkyl groups or C₆H₅ groups. It is preferred, though, that the backbone of compound (a) bears no further substituents other than NH₂-groups and spacers with one or more NH₂-groups.

It is preferred that compound (a) is selected from heteroaromatic hydrocarbons with at least two NH₂-groups per molecule, that means that the backbone is aromatic. Preferred aromatic backbones are

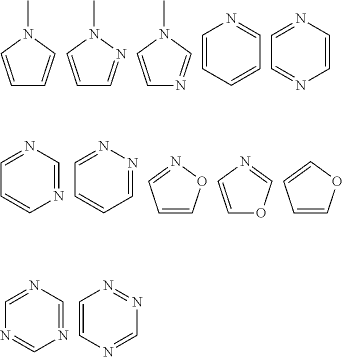

Particularly preferred aromatic backbones are selected from

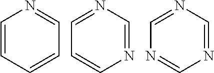

In one embodiment of the present invention, compound (a) is selected from compounds of formula (III),

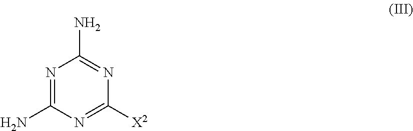

wherein X² is selected from hydrogen, methyl, phenyl, n-hexyl, OH and NH_{2,} preference being given to hydrogen and NH_{2.}

In step (A), compound (a) is converted with at least one compound (b). Compound (b) bears at least two aldehyde groups per molecule, preferred are two to three aldehyde groups per molecule. If mixtures of compounds (b) are to be employed, it is preferred that the average aldehyde group content of the compounds (b) is in the range of from 2 to 3 per mole.

Compound (b) can have one or more functional groups other than aldehyde groups. Suitable functional groups other than aldehyde groups are keto groups, chlorine, and hydroxyl groups.

In a preferred embodiment, compound (b) has no functional groups other than aldehyde groups.

In step (A), compound (b) can be applied with free aldehyde groups or in protected form, e. g.

as acetal moieties, non-cyclic or cyclic. For matters of simplicity, in the context of compound (b) protected aldehyde groups such as acetal moieties are contemplated as aldehyde groups.

It is preferred, though, that compound (b) is employed with free aldehyde groups.

Compound (b) is aromatic, that means compound (b) has a backbone selected from carbocyclic aromatic rings and heterocyclic aromatic rings. The aldehyde groups are directly linked to the backbone, or they are linked through a spacer. Suitable spacers are, e.g., —C(CH₃)₂— and —CH₂CH₂—.

In one embodiment of the present invention, compound (b) can have in the range of from 4 to 30 carbon atoms per molecule, preferably 8 to 20.

Preferred heteroaromatic backbones are

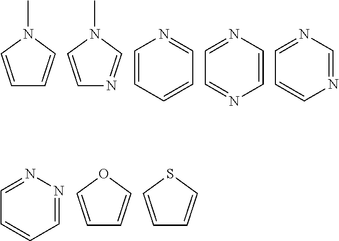

In one embodiment of the present invention, at least one compound (b) is selected from heteroaromatic dialdehydes, heteroaromatic trialdehydes, and carbocyclic aromatic di- and trialdehydes whose aromatic backbone is selected from

phenylene, such as ortho-phenylene, meta-phenylene, and preferably para-phenylene; naphthylene, such as 1,7-naphthylene, 1,8-naphthylene, 1,5-naphthylene, 2,6-naphthylene, biphenylene, such as 2,4′-biphenylene, 2,2′-biphenylene, and in particular 4,4′-biphenylene, fluorenylene, anthracenylene, pyrenylene, perylenylene, indenylenee, 1,1′:4′,1″-terphenylenylene, 1,1′-spirobi[inden]ylene, and 9,9′-spirobi[fluoren]ylen.

In one embodiment of the present invention, carbocyclic aromatic di- and trialydehydes are selected from those whose aromatic backbone is selected from phenylene, naphthylene, and biphenylene.

In one embodiment of the present invention heteroaromatic dialdehydes are selected from molecules of formula (I) and (II)

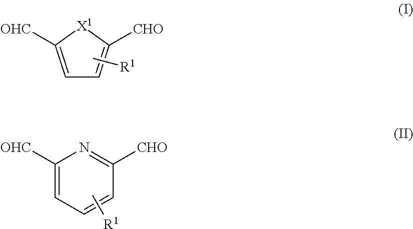

wherein the integers are defined as follows:

R¹ being selected from

C₁-C₆-alkyl, such as methyl, ethyl, n-propyl, iso-propyl, n-butyl, iso-butyl, sec.-butyl, tert.-butyl, n-pentyl, iso-pentyl, iso-Amyl, and n-hexyl, preferably methyl,

benzyl,

C₆-C₁₄-aryl, non-substituted or substituted with one to three C₁-C₄-alkyl per molecule, preferably phenyl, more preferably non-substituted phenyl,

and even more preferably hydrogen,

X¹ being selected from oxygen, sulphur, and N—H, N—H being preferred.

In one embodiment of the present invention, in step (A) at least one compound (a) selected from heterocyclic dialdehydes selected from

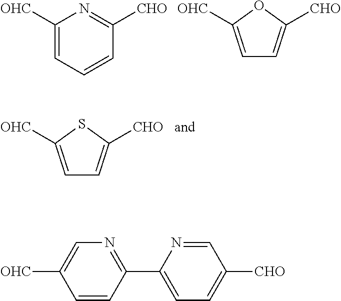 [SMILES: O=Cc1cccc(C=O)n1 ; O=Cc1ccc(C=O)o1 ; O=Cc1ccc(C=O)s1 ; "and" ; O=Cc1ccc(-c2ccc(C=O)cn2)nc1]

and carbocyclic aromatic dialdehydes selected from

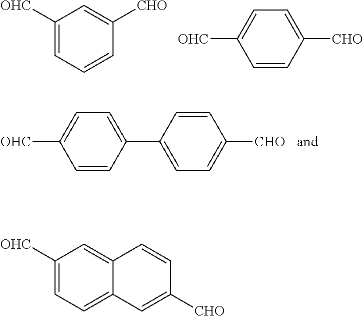

or carbocyclic aromatic trialdehydes selected from

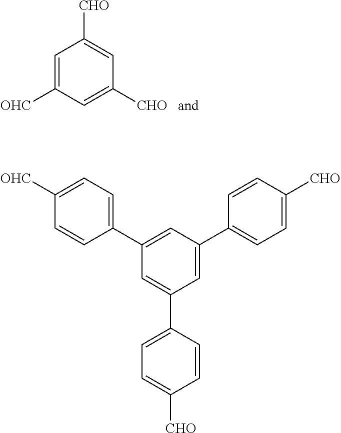 [SMILES: O=Cc1cc(C=O)cc(C=O)c1 ; "and" ; O=Cc1ccc(-c2cc(-c3ccc(C=O)cc3)cc(-c3ccc(C=O)cc3)c2)cc1]

is converted with at least one compound (b) selected from

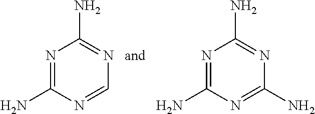 [SMILES: Nc1ncnc(N)n1 ; "and" ; Nc1nc(N)nc(N)n1]

In one embodiment of the present invention, compound (a) and compound (b) are converted in step (A) such that the molar ratio of aldehyde groups to NH₂-groups is in a range of from 2 to 1 to 1 to 2, preferably from 1.5 to 1 to 1 to 1.5, and particular preferably 1:1.

In one embodiment of the present invention, the conversion of compound (a) and compound (b) in step (A) is performed at a temperature in the range of from 150 to 250° C., preferably from 170 to 200° C.

In one embodiment of the present invention, the conversion of compound (a) and compound (b) in step (A) is performed at a pressure in the range of from 0.5 to 10 bar, preferably at normal pressure.

In one embodiment of the present invention, the conversion of compound (a) and compound (b) in step (A) is performed under inert atmosphere, such as nitrogen atmosphere or rare gas atmosphere. In an alternative, step (A) can be performed under air.

In one embodiment of the present invention, conversion of compound (a) and compound (b) in step (A) is performed over a time period in the range of from 1 hour to 7 days, preferably 1 day to 5 days.

In one embodiment of the present invention, compound (a) and compound (b) are converted in step (A) in bulk.

In a preferred embodiment of the present invention, compound (a) and compound (b) are converted in step (A) in the presence of solvent. Particularly preferred solvent is dimethyl sulfoxide (DMSO).

The conversion according to step (A) is preferably being performed in the absence of any solid inorganic material such as inorganic catalysts or inorganic template, such as zeolites or mica.

The conversion according to according to step (A) is preferably being performed in the absence of any natural or synthetic organic polymeric material such as seaweed or silk.

In one embodiment of the present invention, the conversion according to step (A) can be accelerated with an organic catalyst such as a C₁-C₃-carboxylic acid.

In a preferred embodiment of the present invention, the conversion according to step (A) is carried out without any catalyst.

In the course of step (A), water will be formed. The water can be left in the reaction mixture, or it can be removed, e. g., by distillation. It is preferred to distil off the water formed.

In one embodiment of the present invention, the conversion according to step (A) can be performed to a percentage of 10 up to 99 mole-%, referring to the group—aldehyde group or NH₂-group—being present to a lower degree. Preferably, the conversion according to step (A) is in the range of from 60 to 90 mole-% and more preferably in the range of up to 70 mole-%.

By performing step (A), a macromolecular material is being formed which can contain aminal structural elements and Schiff base structural elements. Preferred are animal structural elements.

Before submitting the material resulting from step (A), it is advantageous to remove the solvent(s) if solvent(s) have been employed. Said removal can be performed by distillation, filtration or with the aide of a centrifuge.

With exception of the removal of the—optionally employed—solvent, in many instances the material resulting from step (A) can be submitted without further purification.

In some embodiments, however, it may be advantageous to further purify the material resulting from step (A), for example in order to remove solvents or catalyst, if used. Suitable methods for purification are, e. g., washing, drying under vacuum, and extracting, for example by Soxhlet extraction.

In step (B) of the inventive method, the material obtained from step (A) is being heated in the absence of oxygen to temperatures in the range of from 700 to 1200° C., preferably from 800 to 1000° C.

Absence of oxygen can mean in context with step (B) that heating is to be performed in vaccuo or in inert atmosphere with an oxygen content of less than 0.1% by volume. A suitable inert atmosphere can be provided by performing step (B) in nitrogen or in rare gas, for example in argon atmosphere.

In one embodiment of the present invention, the heating according to step (B) can be performed over a period of time in the range of from 5 minutes to 48 hours, preferably of from 30 minutes to 24 hours.

In one embodiment of the present invention, the heating can be performed rapidly, for example by exposing the material according to step (A) to hot surfaces or radiation of from 1000 to 2000° C.

It is preferred, though, to heat the material according to step (A) in a more slowly fashion, for example by heating at a rate of from 1 to 10 min/° C., preferably 90 seconds to 5 minutes/° C. For calculation of the duration of the reaction according to step (B), the time from reaching a temperature of 700° C., preferably 800° C. will be taken into account.

After finishing of the heating, the material obtained can be cooled to room temperature or any other temperature suitable for analysis or further work-up.

Without wishing to be bound to any theory, it can be assumed that several reactions can take place during step (B). Among others, ammonia and/or other amines can be cleaved off. Ring-opening and ring closing reaction can take place, such as—in the event that

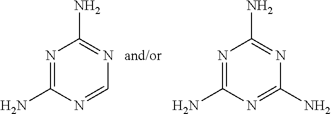

have been chosen as compound(s) (b) in step (A), breaking up of the six-membered triazine rings.

In one embodiment of the present invention, volatile fragments of the material obtained in step (A) can be removed during step (B). Volatile in the context of the present invention refer to materials whose boiling temperature is below the heating temperature in step (B). Such volatile fragments may be water, organic amines, HCN, CH₃CN, NH₃, and volatile unreacted starting materials from step (A).

For the application in e. g., capacitors, the inventive carbonaceous material can be used without further purification.

By the inventive process, a nitrogen-containing carbonaceous material can be obtained that is porous, having a total pore volume in the range of from 0.1 to 3.0 cm³/g, determined by converting the adsorbed gas volume at a relative pressure of p/p₀=0.8 into the corresponding liquid volume using a using a nitrogen density of 1.25·10⁻³ g/cm³ (gaseous) and 8.10·10⁻¹ g/cm³ (liquid). The nitrogen adsorption isotherms can be obtained according to the procedure described in DIN 66135. Said total pore volume refers to pores with an average pore diameter in the range of from 2 to 50 nm, preferably in the range of from 2 to 10 nm.

In one embodiment of the present invention, the average pore diameter of the carbonaceous material obtainable by the inventive process is in the range of from 2 to 50 nm, preferably in the range of from 2 to 10 nm, determined by nitrogen adsorption according to the BJH (Barret-Joyner-Halenda) method, see, e. g., E. P. J. Barrett et al., J. Am. Chem. Soc. 1951, 73, 373.

In one embodiment of the present invention, the carbonaceous material obtainable from the inventive process has a sharp pore diameter distribution. A sharp pore diameter distribution according to the present invention can mean that the width of the peak in a diagram showing the first derivative of the cumulative pore volume, dV(d), as a function of the pore diameter d_{BJH} is in the range of from 2 to 3 nm, determined at half height. In another embodiment, width of the peak in a diagram showing the first derivative of the cumulative pore volume, dV(d), as a function of the pore diameter d_{BJH} is in the range of from 7 to 8 nm, determined at the foot of the peak.

By the inventive process, a nitrogen-containing carbonaceous material can be obtained that can have an inorganic salt content of 1 up to 50 ppm, preferably up to 20 ppm, ppm in the context of the present invention referring to ppm by weight of the overall carbonaceous material. In an even more preferred embodiment, the nitrogen-containing carbonaceous material obtained by the inventive process does not contain any detectable amounts of inorganic salts. The inorganic salt content can be determined by, e. g. atomic absorption spectroscopy or inductive coupled plasma mass spectrometry (ICP-MS).

The nitrogen-containing carbonaceous material obtainable by the inventive process is highly useful as electrode for capacitors and as catalyst or as support for catalysts.

A further aspect of the present invention is a carbonaceous material with a nitrogen content in the range of from 1 to 8, preferably 5 to 7% by weight and with an optional inorganic salt content in the range of up to 50 ppm, preferably 1 to 20 ppm, said carbonaceous material having a BET surface in the range of from 500 to 700 m²/g and a capacitance in the range of from 5 to 100 μF/cm², preferably 6 to 90 μF/cm². Said carbonaceous material can also be referred to as inventive carbonaceous material. The capacitance can be determined, e. g. according to J. R. Miller and A. F. Burke, Electric Vehicle Capacitor Test, Procedures Manual, Idaho National Engineering Laboratory, Report No. DOE/ID-10491, 1994, and/or according to R. B. Wright and C. Motloch, Freedom CAR Ultracapacitor Test, Manual, Idaho National Engineering Laboratory, Report No. DOE/NE ID-11173, 2004.

The nitrogen content can be determined by elemental analysis.

In one embodiment of the present invention, inventive carbonaceous material does not contain any detectable amounts of inorganic salts according to the above methods.

In one embodiment of the present invention, inventive carbonaceous material contains fused carbocyclic aromatic and N-containing heteroaromatic rings.

In one embodiment of the present invention, inventive carbonaceous material has a total pore volume in the range of from 0.1 to 3.0 cm³/g, preferably 0.5 to 1.0 cm³/g, determined by a nitrogen adsorption method essentially according to DIN 66135. Said method includes converting the adsorbed gas volume at a relative pressure of p/p₀=0.8 into the corresponding liquid volume using a nitrogen density of 1.25·10⁻³ g/cm³ (gaseous) and 8.10·10⁻¹ g/cm³ (liquid). The nitrogen adsorption isotherms can be obtained according to the procedure described in DIN 66135.

In one embodiment of the present invention, the average pore diameter of inventive carbonaceous material is in the range of from 2 to 50 nm, preferably in the range of from 2 to 10 nm, determined by nitrogen adsorption according to the BJH (Barret-Joyner-Halenda) method.

In one embodiment of the present invention, inventive carbonaceous material has a sharp pore diameter distribution. A sharp pore diameter distribution according to the present invention can mean that the width of the peak in a diagram showing the first derivative of the cumulative pore volume, dV(d), as a function of the pore diameter d_{BJH} is in the range of from 2 to 3 nm, determined at half height. In another embodiment, width of the peak in a diagram showing the first derivative of the cumulative pore volume, dV(d), as a function of the pore diameter d_{BJH} is in the range of from 7 to 8 nm, determined at the foot of the peak.

In one embodiment of the present invention, inventive carbonaceous material has a total sulphur content in the range of from 0.1 to 1.0% by weight. The sulphur content can be determined by combustion analysis. Said sulphur content can be accomplished if only sulphur-free compounds (a) and (b) are converted in step (A).

In an alternative embodiment of the present invention, inventive carbonaceous material has a total sulphur content in the range of from 0.1 to 1.0% by weight. Said sulphur content can be accomplished if at least one sulphur-containing compound (a) or (b) has been converted in step (A).

In one embodiment of the present invention, inventive carbonaceous material has a sharp pore diameter distribution.

Inventive carbonaceous materials can be advantageously used as electrodes for capacitors. A capacitor can, e. g., contain electrodes containing inventive carbonaceous material. A capacitor according to the preset invention can additionally contain a counter electrode. Counter electrodes can be made from, e.g. platinum or carbon, such as carbon including a binder material, binder materials briefly also being referred to as binder.

A further aspect of the present invention is an electrode, comprising at least one inventive carbonaceous material and at least one binder.

In an embodiment of the present invention, inventive carbonaceous material can be mixed with a binder to form an electrode for a capacitor according to the present invention. Suitable binders are selected from organic polymers, especially water-insoluble organic polymers, whereby the expression polymers can also encompass copolymers. Preferred water-insoluble polymers are fluorinated polymers such as polyvinylidene fluoride, polyvinyl fluoride, polytetrafluoroethylene, copolymers from tetrafluoroethylene and hexafluoro propylene, copolymers from vinylidene fluoride and hexafluoro propylene or copolymers from vinylidene fluoride and tetrafluoroethylene. For the purpose of the present invention, vinylidene fluoride can also be referred to as vinylidene difluoride, and polyvinylidene fluoride can also be referred to as polyvinylidene difluoride.

In an embodiment of the present invention, inventive electrodes furthermore comprise at least one inventive carbonaceous material and at least one binder.

In an embodiment of the present invention, inventive carbonaceous material can be mixed with a binder and at least one additive to form an electrode for a capacitor according to the present invention. Suitable additives are soot, carbon black, and activated carbon.

Inventive electrodes are connected through one or more current collectors to at least one other component of the capacitor. In the context of the present invention, said current collector will not be considered as component of the inventive electrode.

Inventive electrodes can further comprise a backbone, such as a metal foil or a metal gauze. Suitable metal foils can be made from, e. g., nickel. Suitable metal gauze can be made from steel, in particular from stainless steel. In the context of the present invention, said current backbone will not be considered as component of the inventive electrode.

In one embodiment of the present invention, inventive electrodes comprise

in the range of from 50 to 90% by weight of inventive carbonaceous material, preferably 75 to 85% by weight,

in the range of from 1 to 20% by weight binder, preferably 7.5 to 15% by weight,

a total in the range of from zero to 20% by weight additive(s), preferably 7.5 to 15% by weight, referring to the total sum of components of said inventive electrode.

Inventive electrodes can further comprise or be soaked with an electrolyte. Examples for electrolytes are sulphuric acid, aqueous potassium hydroxide solutions, and so-called ionic liquids, for example 1,3-disubstituted imidazolium salts. Preferred 1,3-disubstituted imidazoliuim salts correspond to formula (IV)

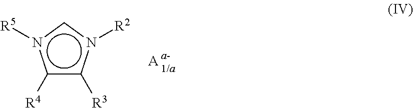

wherein

R², R³, R⁴ and R⁵ are each, independently of one another, a carbon-comprising organic, saturated or unsaturated, acyclic or cyclic, aliphatic, aromatic or araliphatic radical which has from 1 to 30 carbon atoms and may comprise one or more heteroatoms and/or be substituted by one or more functional groups or halogens, where adjacent radicals R² and R³, R³ and R⁴ or R⁴ and R⁵ may also be joined to one another and the radicals R³ and R⁴ may each also be, independently of one another, hydrogen, halogen or a functional group,

and A^{a-} being selected from

fluoride; hexafluorophosphate; hexafluoroarsenate; hexafluoroantimonate; trifluoroarsenate; nitrite; nitrate; sulfate; hydrogensulfate; carbonate; hydrogencarbonate; phosphate; hydrogenphosphate; dihydrogenphosphate; vinyl phosphonate; dicyanamide; bis(pentafluoroethyl)phosphinate; tris(pentafluoroethyl)trifluorophosphate; tris(heptafluoropropyl)trifluorophosphate; bis[oxalato(2-)]borate; bis[salicylato(2-)]borate; bis[1,2-benzenediolato(2-)O,O′]borate; tetracyanoborate; tetracarbonylcobaltate; tetrasubstituted borate of the formula (Va) [BR^{a}R^{b}R^{c}R^{d}]⁻, where R^{a} to R^{d} are each, independently of one another, fluorine or a carbon-comprising organic, saturated or unsaturated, acyclic or cyclic, aliphatic, aromatic or araliphatic radical which has from 1 to 30 carbon atoms and may comprise one or more heteroatoms and/or be substituted by one or more functional groups or halogens;

organic sulfonate of the formula (Vb) [R^{e}—SO₃]⁻, where R^{e} is a carbon-comprising organic, saturated or unsaturated, acyclic or cyclic, aliphatic, aromatic or araliphatic radical which has from 1 to 30 carbon atoms and may comprise one or more heteroatoms and/or be substituted by one or more functional groups or halogens;

carboxylate of the formula (Vc) [R^{f}—COO]⁻, where R^{f} is hydrogen or a carbon-comprising organic, saturated or unsaturated, acyclic or cyclic, aliphatic, aromatic or araliphatic radical which has from 1 to 30 carbon atoms and may comprise one or more heteroatoms and/or be substituted by one or more functional groups or halogens;

(fluoroalkyl)fluorophosphates of the formula (Vd) [PFₓ(C_{y}F_{2y+1+z}H_{z})₆₋ₓ]⁻, where 1≦x≦6, 1≦y≦8 and 0≦z≦2y+1;

imide of the formula (Ve) [R^{g}—SO₂—N—SO₂—R^{h}]—, (Vf) [Rⁱ—SO₂—N—CO—R^{j}]—or (Vg) [R^{k}—CO—N—CO—R^{l}]—, where R^{g} to R^{l} are each, independently of one another, hydrogen or a carbon-comprising organic, saturated or unsaturated, acyclic or cyclic, aliphatic, aromatic or araliphatic radical which has from 1 to 30 carbon atoms and may comprise one or more heteroatoms and/or be substituted by one or more functional groups or halogens;

A further aspect of the present invention is a process for manufacturing electrodes, preferably electrodes for capacitors, under use of inventive carbonaceous materials. Said process can be referred to as inventive manufacturing process.

In one embodiment of the present invention, the inventive manufacturing process comprises the steps of mixing at least one inventive carbonaceous material with at least one binder and optionally at least one additive in the presence of water. By said mixing, an aqueous formulation will be formed, for example an aqueous paste or slurry. Said paste or slurry can be used for applying the mixture so obtained, e. g., by coating a material with the paste or slurry, followed by drying. Coating can be performed, e. g., by using a squeegee, a roller blade, or a knife.

Drying can be performed, e. g., in a drying cabinet or a drying oven. Suitable temperatures are 50 to 150° C. Drying can be achieved at normal pressure or at reduced pressure, for example at a pressure in the range of from 1 to 500 mbar.

A further aspect of the present invention is the use of inventive carbonaceous materials as catalyst or as support for catalysts. Inventive carbonaceous materials can, for example, serve as catalyst for reactions such as

A further aspect of the present invention are catalysts, containing an inventive carbonaceous material. Such inventive catalysts can contain inventive material as catalytically active material or as support for a catalytically active material.

In a special embodiment of the present invention, inventive carbonaceous material is used as support for 2,2′-bipyridyl platinum dichloride in order to catalyze the oxidation of methane to methanol.

### THE PRESENT INVENTION IS FURTHER ILLUSTRATED BY MEANS OF EXAMPLES

### I. Conversion of Compounds (b) with Compounds (a)

### I.1 Conversion of melamine (b.1) with terephthalaldehyde (a.1): Preparation of Material (A1.1)

A flame dried Schlenk flask fitted with a condenser and a magnetic stirring bar was charged with melamine (b.1) (313 mg, 2.49 mmol), terephthalaldehyde (a.1) (500 mg, 3.73 mmol) and dimethyl sulfoxide (15.5 ml). After degassing by argon bubbling the resulting mixture was heated to 180° C. for 72 hours under argon atmosphere. After cooling to room temperature the precipitated material (A1.1) was isolated by filtration over a Büchner funnel and subjected to Soxhlet extraction with tetrahydrofuran (THF). The solvent was removed under vacuum at room temperature to afford the material (A1.1) as off-white powder in 61% yield.

### I.2 Conversion of melamine (b.1) with biphenyl-4,4′-dicarbaldehyde (a.2): Preparation of Material (A2.1)

A flame dried Schlenk flask fitted with a condenser and a magnetic stirring bar was charged with melamine (b.1) (200 mg, 1.59 mmol) and biphenyl-4,4′-dicarbaldehyde (a.2) (500 mg, 2.38 mmol) and dimethyl sulfoxide (11.0 ml). After degassing by argon bubbling the resulting mixture was heated to 180° C. for 72 hours under argon atmosphere. After cooling to room temperature the precipitated material (A2.1) was isolated by filtration over a Büchner funnel and subjected to Soxhlet extraction with THF. The solvent was removed under vacuum at room temperature to afford the material (A2.1) as off-white powder in 62% yield.

### I.3 Conversion of melamine (b.1) with isophthalalydehyde (a.3): Preparation of Material (A3.1)

A flame dried Schlenk flask fitted with a condenser and a magnetic stirring bar was charged with melamine (b.1) (313 mg, 2.49 mmol) and isophthalalydehyde (a.3) (500 mg, 3.73 mmol) and dimethyl sulfoxide (15.5 ml). After degassing by argon bubbling the resulting mixture was heated to 180° C. for 72 hours under argon atmosphere. After cooling to room temperature the precipitated material (A3.1) was isolated by filtration over a Büchner funnel and subjected to Soxhlet extraction with THF. The solvent was removed under vacuum at room temperature to afford the material (A3.1) as off-white powder in 62% yield.

### I.4 Conversion of melamine (b.1) with 1,3,5-tris(4-formylphenyl)benzene (a.4): Preparation of Material (A4.1)

A flame dried Schlenk flask fitted with a condenser and a magnetic stirring bar was charged with melamine (b.1) (124 mg, 0.98 mmol) and 1,3,5-tris(4-formylphenyl)benzene (a.4) (383 mg, 0.98 mmol) and dimethyl sulfoxide (4.9 ml). After degassing by argon bubbling the resulting mixture was heated to 180° C. for 72 hours under argon atmosphere. After cooling to room temperature the precipitated material (A4.1) was isolated by filtration over a Büchner funnel and subjected to Soxhlet extraction with THF. The solvent was removed under vacuum at room temperature to afford the material (A4.1) as off-white powder in 66% yield.

### I. 5 Conversion of melamine (b.1) with naphthalene-2,6-dicarbaldeyde (a.5): Preparation of Material (A5.1)

A flame dried Schlenk flask fitted with a condenser and a magnetic stirring bar was charged with melamine (b.1) (231 mg, 1.81 mmol) and naphthalene-2,6-dicarbaldeyde (a.5) (500 mg, 2.715 mmol) and dimethyl sulfoxide (11.3 ml). After degassing by argon bubbling the resulting mixture was heated to 180° C. for 72 hours under argon atmosphere. After cooling to room temperature the precipitated material (A5.1) was isolated by filtration over a Büchner funnel and subjected to Soxhlet extraction with THF. The solvent was removed under vacuum at room temperature to afford the material (A5.1) as off-white powder in 66% yield.

### 1.6 Conversion of melamine (b.1) with benzene-1,3,5-tricarbaldehyde (a.6): Preparation of Material (A6.1)

A flame dried Schlenk flask fitted with a condenser and a magnetic stirring bar was charged with melamine (b.1) (389 mg, 3.08 mmol) and benzene-1,3,5-tricarbaldehyde (a.6) (500 mg, 3.083 mmol) and dimethyl sulfoxide (15.0 ml). After degassing by argon bubbling the resulting mixture was heated to 180° C. for 72 hours under argon atmosphere. After cooling to room temperature the precipitated material (A6.1) was isolated by filtration over a Büchner funnel and subjected to Soxhlet extraction with THF. The solvent was removed under vacuum at room temperature to afford the material (A6.1) as off-white powder in 68% yield.

### I.7 Conversion of melamine (b.1) with pyridine-2,6-dicarbaldeyde (a.7): Preparation of Material (A7.1)

A flame dried Schlenk flask fitted with a condenser and a magnetic stirring bar was charged with melamine (b.1) (311 mg, 2.467 mmol) and pyridine-2,6-dicarbaldehyde (a.7) (500 mg, 3.700 mmol) and dimethyl sulfoxide (15.4 ml). After degassing by argon bubbling the resulting mixture was heated to 180° C. for 72 hours under argon atmosphere. After cooling to room temperature the precipitated material (A3.1) was isolated by filtration over a Büchner funnel and subjected to Soxhlet extraction with THF. The solvent was removed under vacuum at room temperature to afford the material (A7.1) as off-white powder in 75% yield.

### I. 8 Conversion of melamine (b.1) with 2,2′-bipyridine-5,5′-dicarbaldehyde (a.8): Preparation of Material (A8.1)

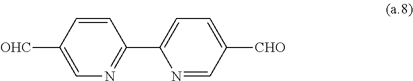 [SMILES: O=Cc1ccc(-c2ccc(C=O)cn2)nc1]

A flame dried Schlenk flask fitted with a condenser and a magnetic stirring bar was charged with melamine (b.1) (198 mg, 1.571 mmol), 2,2′-bipyridine-5,5′-dicarbaldehyde (a.8) (500 mg, 2.357 mmol) and dimethyl sulfoxide (9.8 ml). After degassing by argon bubbling the resulting mixture was heated to 180° C. for 72 hours under argon atmosphere. After cooling to room temperature the precipitated material (A8.1) was isolated by filtration over a Büchner funnel and subjected to Soxhlet extraction with THF. The solvent was removed under vacuum at room temperature to afford the material (A8.1) as off-white powder in 60% yield.

### 1.9 Conversion of melamine (b.1) with thiophene-2,5-dicarbaldehyde (a.9): Preparation of Material (A9.1)

A flame dried Schlenk flask fitted with a condenser and a magnetic stirring bar was charged with melamine (b.1) (300 mg, 2.378 mmol) and thiophene-2,5-dicarbaldehyde (a.9) (500 mg, 3.567 mmol) and dimethyl sulfoxide (14.9 ml). After degassing by argon bubbling the resulting mixture was heated to 180° C. for 72 hours under argon atmosphere. After cooling to room temperature the precipitated material (A9.1) was isolated by filtration over a Büchner funnel and subjected to Soxhlet extraction with THF. The solvent was removed under vacuum at room temperature to afford the material (A9.1) as brown powder in 62% yield.

### I.10 Conversion of melamine (b.1) with furan-2,5-dicarbaldehyde (a.10): Preparation of Material (A10.1)

A flame dried Schlenk flask fitted with a condenser and a magnetic stirring bar was charged with melamine (b.1) (339 mg, 2.686 mmol) and furan-2,5-dicarbaldehyde (a.10) (500 mg, 4.029 mmol) and dimethyl sulfoxide (16.8 ml). After degassing by argon bubbling the resulting mixture was heated to 180° C. for 72 hours under argon atmosphere. After cooling to room temperature the precipitated material (A10.1) was isolated by filtration over a Büchner funnel and subjected to Soxhlet extraction with THF. The solvent was removed under vacuum at room temperature to afford the material (A10.1) as brown powder in 58% yield.

### I. 11 Conversion of 2,4-diamino triazine (b.2) with 1,3,5-tris(4-formylphenyl)benzene (a.4): Preparation of Material (A4.2)

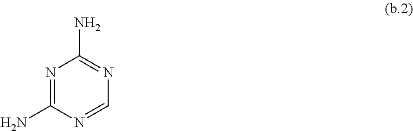

A flame dried Schlenk flask fitted with a condenser and a magnetic stirring bar was charged with 2,4-diamino triazine (b.2) (250 mg, 2.250 mmol) and 1,3,5-tris(4-formylphenyl)benzene (a.4) (878 mg, 2.250 mmol) and dimethyl sulfoxide (11.2 ml). After degassing by argon bubbling the resulting mixture was heated to 180° C. for 72 hours under argon atmosphere. After cooling to room temperature the precipitated material (A4.2) was isolated by filtration over a Büchner funnel and subjected to Soxhlet extraction with THF. The solvent was removed under vacuum at room temperature to afford the material (A4.2) as off-white powder in 60% yield.

### I. 12 Conversion of 2,4-diamino triazine (b.2) with benzene-1,3,5-tricarbaldehyde (a.6): Preparation of Material (A4.2)

A flame dried Schlenk flask fitted with a condenser and a magnetic stirring bar was charged with 2,4-diamino triazine (b.2) (250 mg, 2.250 mmol) and benzene-1,3,5-tricarbaldehyde (a.6) (365 mg, 2.250 mmol) and dimethyl sulfoxide (11.2 ml). After degassing by argon bubbling the resulting mixture was heated to 180° C. for 72 hours under argon atmosphere. After cooling to room temperature the precipitated material (A6.2) was isolated by filtration over a Büchner funnel and subjected to Soxhlet extraction with THF. The solvent was removed under vacuum at room temperature to afford the material (A6.2) as off-white powder in 59% yield.

TABLE 1
Analytical data of materials resulting from step (A)

| | C | H | N | S | C/H | C/N | S_{BET} | MPV_{(0.1)} | PV_{(0.8)} | d_{BJH} | PV_{BJH} |
|---|---|---|---|---|---|---|---|---|---|---|---|
| No. | [wt %] | [wt %] | [wt %] | [wt %] | ratio | ratio | [m²/g] | [cm³/g] | [cm³/g] | [nm] | [cm³/g] |
| (A1.1) | 38.60 | 4.32 | 38.02 | 1.52 | 8.94 | 1.02 | 1377 | 0.56 | 1.01 | 3.33 | 2.96 |
| (A2.1) | 40.31 | 4.57 | 35.94 | 3.44 | 8.82 | 1.12 | 842 | 0.36 | 0.62 | 3.76 | 1.87 |
| (A3.1) | 41.31 | 4.77 | 40.42 | 3.85 | 8.66 | 1.02 | 1133 | 0.48 | 0.84 | 3.29 | 1.68 |
| (A4.1) | 46.57 | 4.41 | 41.73 | 0.60 | 10.56 | 1.12 | 1213 | 0.48 | 0.69 | 3.36 | 3.66 |
| (A5.1) | 37.91 | 4.41 | 35.88 | 0.80 | 8.60 | 1.06 | 1032 | 0.43 | 0.73 | 3.80 | 0.71 |
| (A6.1) | 41.78 | 4.65 | 33.49 | 2.21 | 8.98 | 1.25 | 639 | 0.24 | 0.57 | 2.99 | 3.62 |
| (A7.1) | 42.50 | 4.50 | 37.93 | 0.23 | 9.44 | 1.12 | 541 | 0.19 | 0.51 | 3.39 | 3.75 |
| (A8.1) | 38.50 | 4.17 | 35.96 | 3.84 | 9.23 | 1.07 | 730 | 0.28 | 0.67 | 1.87 | 3.29 |
| (A9.1) | 43.33 | 3.80 | 43.77 | 13.89 | 11.40 | 0.99 | 216 | 0.09 | 0.22 | 3.87 | 0.16 |
| (A10.1) | 45.92 | 4.02 | 23.89 | 5.24 | 11.42 | 1.92 | 251 | 0.06 | 0.22 | 3.83 | 0.24 |
| (A4.2) | 39.75 | 4.66 | 44.60 | 1.40 | 8.53 | 0.89 | 220 | 0.08 | 0.25 | 3.01 | 0.86 |
| (A6.2) | 36.49 | 2.98 | 37.86 | 1.90 | 12.24 | 0.96 | 199 | 0.07 | 0.21 | 3.42 | 1.40 |

The contents of carbon, hydrogen, sulphur and nitrogen as well as the C/H and the C/N ratio were determined by combustion analysis. The C/H ratio and the C/N ratio refer to ratio by weight.

S_{BET}: BET surface, determined with nitrogen according to DIN 66135 (measurements) and DIN 66131 (evaluation, calculations).

MPV_{(0.1)}: meso pore volume, determined by nitrogen adsorption, determined at a relative pressure p/p₀=0.1. The gas adsorbed can be recalculated into an amount of liquid which corresponds to the pore volume at the respective relative pressure.

PV_{(0.8)}: pore volume, determined by nitrogen adsorption at a relative pressure p/p₀=0.8 by converting the adsorbed gas volume at a relative pressure of p/p₀=0.1 into the corresponding liquid volume using a using a nitrogen density of 1.25·10⁻³ g/cm³ (gaseous) and 8.10·10⁻¹ g/cm³ (liquid).

d_{BJH}: average pore diameter according to the BJH method, DIN 66134.

PV_{BJH}: pore volume according to the BJH method, DIN 66134.

### II. Step (B) Heating of Materials According to Step (A)

General procedure: A sample of material according to step (A) (120 mg) was placed in a quartz boat and heated under an argon flow to the temperature according to table 2 with a heating rate of 2° C./min. The sample was held at the respective temperature for 1 hour. After cooling, the respective inventive material was recovered as a black powder.

TABLE 2
Synthesis and analytic data of inventive materials

| | | T | C | H | N | C/H | C/N | S_{BET} | MPV_{(0.1)} | PV_{(0.8)} | d_{BJH} | PV_{BJH} |
|---|---|---|---|---|---|---|---|---|---|---|---|---|
| No. | St. M. | [° C.] | [wt %] | [wt %] | [wt %] | ratio | ratio | [m²/g] | [cm³/g] | [cm³/g] | [nm] | [cm³/g] |
| (B1.1-400) | (A1.1) | 400 | 48.95 | 2.96 | 41.21 | 16.54 | 1.19 | 219 | 0.08 | 0.21 | 16.75 | 1.46 |
| (B1.1-600) | (A1.1) | 600 | 64.53 | 1.54 | 21.19 | 41.90 | 3.05 | 678 | 0.31 | 0.52 | 20.16 | 1.91 |
| (B1.1-800) | (A1.1) | 800 | 83.74 | 0.82 | 7.11 | 102.12 | 11.78 | 585 | 0.24 | 0.58 | 8.94 | 0.90 |
| (B1.1-1200) | (A1.1) | 1200 | 90.32 | 0.96 | 1.93 | 94.08 | 46.80 | 275 | 0.10 | 0.29 | 7.45 | 0.86 |
| (B2.1-800) | (A2.1) | 800 | 85.73 | 0.54 | 5.63 | 158.76 | 15.23 | 699 | 0.29 | 0.60 | 28.17 | 2.17 |
| (B2.1-1200) | (A2.1) | 1200 | 90.63 | 0.62 | 1.13 | 146.18 | 80.20 | 643 | 0.26 | 0.55 | 28.08 | 2.55 |
| (B3.1-800) | (A3.1) | 800 | 78.42 | 0.66 | 6.05 | 85.13 | 12.96 | 748 | 0.34 | 0.62 | 3.89 | 0.51 |
| (B3.1-1200) | (A3.1) | 1200 | 87.74 | 0.235 | 1.18 | 373.36 | 74.36 | 454 | 0.19 | 0.42 | 3.93 | 0.52 |

St. M.: starting material for step (B)
T: maximum temperature of respective step (B)

### III. Electrochemical Testing

Inventive electrodes were prepared as follows. Inventive carbonaceous material and carbon black (Mitsubishi Chemicals, Inc., carbon content >99.9%) were mixed in a weight ratio of 8:1 in an agate mortar until a homogeneous black powder was obtained. To this mixture, an aqueous PTFE binder emulsion (solids content 60%, commercially available from Sigma) was added together with a few drops of ethanol, the amount of PTFE being 10% by weight in respect to solids contents of the binder and the weight ratio of inventive carbonaceous material:carbon black:binder being 8:1:1. After brief evaporation by drying in air, the resulting paste was pressed at 5 MPa to nickel mesh (for the experiments with 1M KOH electrolyte) or stainless gauze (for the experiments with 1M H₂SO₄ electrolyte), each nickel mesh and stainless gauze being attached to a stainless wire for electric connection, and each having a size of 1 cm·1 cm. Inventive electrodes were obtained. The inventive electrodes were dried for 16 h at 80° C. in air. Each electrode contained 3 to 5 mg inventive carbonaceous material and had a geometric surface area of about 1 cm². Then a platinum foil was applied as a counter electrode with a standard calomel electrode (SCE) or a Ag/AgCl electrode as a reference electrode.

TABLE 3
Electrochemical data of inventive materials, determined with
aqueous 1M H₂SO₄ as electrolyte, inventive
carbonaceous materials applied to nickel foil

| | 2 A/g | | 5 A/g | | 10 A/g | |
|---|---|---|---|---|---|---|
| | C_{g} | Cₛ | C_{g} | Cₛ | C_{g} | Cₛ |
| No. | [F/g] | [μF/cm²] | [F/g] | [μF/cm²] | [F/g] | [μF/cm²] |
| (B1.1-800) | 301 | 51 | 285 | 48 | 220 | 37 |
| (B5.1-800) | 86 | 12 | 75 | 11 | 66 | 12 |
| (B7.1-800) | 351 | 43 | 302 | 37 | 244 | 31 |

TABLE 4
Electrochemical data of inventive materials, determined with
aqueous 1M KOH as electrolyte, inventive carbonaceous
materials applied to stainless gauze

| | 2 A/g | | 5 A/g | | 10 A/g | |
|---|---|---|---|---|---|---|
| | | Cₛ | C_{g} | Cₛ | C_{g} | Cₛ |
| No. | C_{g} [F/g] | 8 μF/cm²] | [F/g] | [μF/cm²] | [F/g] | [μF/cm²] |
| (B1.1-800) | 381 | 72 | 339 | 60 | 253 | 47 |
| (B5.1-800) | 80 | 11 | 68 | 10 | 55 | 8 |
| (B7.1-800) | 184 | 26 | 171 | 23 | 142 | 19 |

Electrochemical characterizations were conducted on an EG&G potentiostat/galvanostat Model 2273 advanced electrochemical system. A conventional cell with a three-electrode configuration was employed.

A platinum foil was applied as a counter electrode with a standard calomel electrode or an Ag/AgCl electrode as a reference electrode. The experiments were carried out in nitrogen saturated 1 M H₂SO₄ or 1 M KOH solutions. The potential range was −1.00 to 0.00 V (SCE) or −0.05 to +0.95 V (Ag/AgCl) at different scan rates. All measurements were performed at room temperature.

Normalized gravimetric capacitance values, C_{g}, were calculated from galvanostatic discharge curves measured in a three-electrode cell using the following equation (1):

C_{g}=(l·t)/(m·ΔV) (1)

where l is the specific discharge current density, t is the overall discharge time, ΔV is the potential range, m is the mass of electrode material. The corresponding volumetric Cₛ values can be obtained by dividing C_{g} by the BET surface area of the respective carbonaceous material.

1. A process for manufacturing a porous carbonaceous material comprising nitrogen, with an optional inorganic salt content of up to 50 ppm by weight, the process comprising:
reacting
a heterocyclic hydrocarbon comprising at least two NH₂-groups per molecule with
an aromatic compound comprising at least two aldehyde groups per molecule, and
heating in an absence of oxygen to a temperature of from 700 to 1200° C.,
wherein the aromatic compound comprises a backbone selected from the group consisting of a carbocyclic aromatic ring and a heterocyclic aromatic ring, and
the aldehyde groups are directly linked to the backbone.

2. The process according to claim 1, wherein the heterocyclic hydrocarbon is selected from heteroaromatic hydrocarbons with at least two NH₂-groups per molecule.

3. The process according to claim 1, wherein the aromatic compound is selected from the group consisting of heteroaromatic dialdehyde, heteroaromatic trialdehyde, carbocyclic aromatic dialdehyde, and carbocyclic aromatic trialdehyde, in which an aromatic backbone is selected from the group consisting of phenylene, naphthylene, biphenylene, fluorenylene, anthracenylene, pyrenylene, perylenylene, indenylenee, 1,1′:4′,1″-terphenylenylene, 1,1′-spirobi[inden]ylene, and 9,9′-spirobi[fluoren]ylen.

4. The process according to claim 1, wherein the aromatic compound is a heteroaromatic dialdehyde selected from molecules of formula (I) and (II) 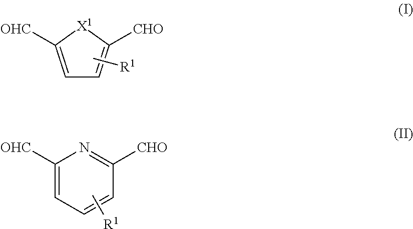
wherein:
R¹ is selected from the group consisting of hydrogen, C₁-C₆-alkyl, benzyl, and C₆-C₁₄-aryl, wherein R¹ is non-substituted or substituted with one to three C₁-C₄-alkyl per molecule, and
X¹ is selected from the group consisting of oxygen, sulphur, and N—H.

5. The process according to claim 1, wherein the reacting is performed in DMSO as solvent.

6. The process according to claim 1, wherein the reacting does not comprise a catalyst comprising a metal ion.

7. The process according to 6 claim 1, wherein the heterocyclic hydrocarbon is selected from compounds of formula (III), 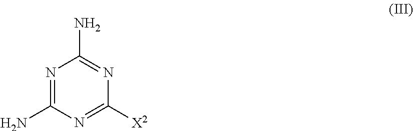
wherein X² is selected from the group consisting of hydrogen, methyl, phenyl, n-hexyl, OH and NH₂.

8. A carbonaceous material having a nitrogen content of from 1 to 8% by weight and an optional inorganic salt content up to 50 ppm, a BET surface of from 500 to 700 m²/g and a capacitance of from 5 to 100 μF/cm².

9. The carbonaceous material according to claim 8, comprising fused aromatic and N-containing heteroaromatic rings.

10. The carbonaceous material according to claim 8, wherein the carbonaceous material has a total pore volume of from 0.1 to 3.0 cm³/g, determined by nitrogen adsorption method essentially according to DIN 66135.

11. The carbonaceous material according to claim 8, wherein the carbonaceous material has a total sulphur content of from 0.1 to 1.0% by weight.

12. The carbonaceous material according to claim 8, wherein the carbonaceous material is obtained by a process comprising:
reacting a heterocyclic hydrocarbon comprising at least two NH₂-groups per molecule with an aromatic compound comprising at least two aldehyde groups per molecule, and
heating in an absence of oxygen to a temperature of from 700 to 1200° C.,
wherein the aromatic compound comprises a backbone selected from the group consisting of a carbocyclic aromatic ring and a heterocyclic aromatic ring, and
the aldehyde groups are directly linked to the backbone.

13. The carbonaceous material according to claim 8, wherein the material is suitable for capacitors.

14. The carbonaceous material according to claim 8, wherein the material is suitable as a catalyst or as a support for catalysts.

15. A catalyst comprising a carbonaceous material according to claim 8.

16. An electrode comprising carbonaceous material according to claim 8 and at least one a binder.

17. The electrode according to claim 16, further comprising an additive.

18. A process for manufacturing electrodes according to claim 16, the process comprising:
mixing a carbonaceous material with a binder and optionally an additive in the presence of water to obtain a mixture;
applying the mixture to a metal filmy and
drying
wherein the carbonaceous material has a nitrogen content of from 1 to 8% by weight, an optional inorganic salt content up to 50 ppm, a BET surface of from 500 to 700 m²/g, and a capacitance of from 5 to 100 μF/cm².
